(19) United States
(12) Patent Application Publication
(10) Pub. No.: US 2025/0128341 A1
(43) Pub. Date: Apr. 24, 2025

(54) CUTTING APPARATUS

(71) Applicant: STEVE VICK INTERNATIONAL LTD., Bath and North East Somerset (GB)

(72) Inventors: Thomas Alexander Gray, Corsham (GB); Alexander R. Phillips, Trowbridge (GB); Richard Ditte, Bath (GB)

(21) Appl. No.: 18/691,659

(22) PCT Filed: Jul. 15, 2022
(86) PCT No.: PCT/EP2022/069960

§ 371 Date: Mar. 13, 2024

(30) Foreign Application Priority Data
Sep. 13, 2021 (GB) 2113041.4

(51) Int. Cl. B23D 21/04

(52) U.S. Cl. CPC B23D 21/04

(57) ABSTRACT

The present disclosure relates to a pipe cutting apparatus for forming a circumferentially-extending cut around a pipe having an elongate axis. The apparatus comprises a support having a track at least partially defining a pipe receiving channel having an axis, with an inner surface configured to abut a pipe within the pipe receiving channel. The apparatus further comprises a cutting tool supported by the support, wherein the cutting tool is a milling tool. The present invention also relates to a cutting apparatus comprising: a cutting tool; a motor for driving the cutting tool, the motor having a motor exhaust for expelling exhaust gas therethrough; a chamber which at least partially surrounds at least a portion of the cutting tool; and a swarf collection hose having a first end fluidly connected to the chamber, wherein the motor exhaust is connected to the swarf collection hose downstream of the chamber along a swarf collection direction such that, in use, a pressure differential is developed between the chamber and the swarf collection hose downstream of its connection with the motor exhaust, thereby suctioning swarf away from the cutting tool.

### FIELD OF THE INVENTION

The present invention relates to a pipe cutting apparatus and particularly, although not exclusively, to a pipe cutting apparatus for cutting service pipes such as gas mains. The present invention also relates to cutting apparatus e.g. a pipe cutting apparatus for cutting service pipes such as gas mains, with improved swarf collection.

### BACKGROUND

Pipe cutting (e.g. cutting of service pipes such as gas mains) has typically been carried out using hand held tools such as disc cutters which is physically challenging and time consuming for the user. Use of such tools is also often hazardous as the user is exposed to the blade. Furthermore, sparks arising as a result of the tool being used to cut metal service pipes are highly undesirable in environments where gas is present.

Developments have seen disc cutters mounted to chains or frames that encircle the pipe thus securing the tool in position and facilitating the passage of the tool around the circumference of the pipe. However, the pipe is often under a compressive force which can compress and jam the cutting disc. Furthermore, a major portion of the cutting disc remains exposed with the cutting disc producing high amounts of torque which presents a hazard to the user. A further hazard is that swarf produced during the cutting operation by the disc is accelerated outwards by the cutting disc which also increases the time necessary to decontaminate the area around the cutting operation.

The present invention has been devised in light of the above considerations.

### SUMMARY

In a first aspect, there is provided a pipe cutting apparatus for forming a circumferentially-extending cut around a pipe having an elongate axis, said apparatus comprising:
a support having a track at least partially defining a pipe receiving channel having an axis, and having an inner surface configured to abut a pipe within the pipe receiving channel; and
a cutting tool supported by the support, wherein the cutting tool is a milling tool.

By using a milling tool rather than a cutting disc, jamming of the cutting tool by compressive forces in the pipe is far less likely because the milling tool cuts using multiple cutting edges on the end of a cylindrical shank rather than a single toothed edge.

Furthermore, the cutting edges of the milling tool have a much smaller footprint than a cutting disc and so are more easily guarded. Indeed, during the cutting operation, cutting edges of the milling tool are almost entirely within the pipe wall so out of reach of accidental contact by a user. Yet furthermore, a milling tool creates a lower torque than a cutting disc which further reduces the hazard to the user. Finally, swarf produced during cutting with a milling tool is not projected over such a wide area as a cutting disc.

Optional features will now be set out. These are applicable singly or in any combination with any aspect or embodiment.

The support e.g. the track is for at least partially encircling a circumference of a pipe inserted within the receiving channel i.e., in use, the axis of the receiving channel is aligned with the axis of the pipe.

In some embodiments, the support is configured to completely encircle the pipe i.e. the support has a substantially circular cross-section transverse to the axis of the receiving channel (and the axis of the pipe).

In some embodiments, the circumferential length of the support e.g. the track is adjustable. This allows the receiving channel to accommodate different sized pipes, for example between 250 and 630 mm.

In addition, the adjustability of the circumferential length of the support/track allows the apparatus to be alternately configured in a non-cutting configuration (for insertion/removal of a pipe within the pipe receiving channel) and a cutting configuration (where the inner surface of the support/track is in abutment with the circumference of the pipe).

The support may be configured to rotate around the axis of the receiving channel/pipe.

In some embodiments, the support e.g. the track may comprise at least one roller to allow rotation of the support, the at least one roller providing the inner surface of the support/track. To allow such rotation, the or each roller has an axis of rotation parallel to the axis of the receiving channel/pipe.

In preferred embodiments, there is a plurality of rollers. The rollers may be equally spaced along the circumferential length of the track.

The at least one or each roller may be at least partly formed of a resilient material e.g. a resilient plastic material such as rubber. For example, the surface of the/each roller may comprise the resilient material.

The plurality of rollers may be provided in a/a plurality of pairs around along the circumferential length of the track, the two rollers in the/each pair being axially spaced in a direction parallel to the axis of the receiving channel/pipe.

The rollers in the/each pair may be connected and spaced by a respective support rod. The rollers may be rotatable about their respective support rod. Adjacent support rods may be connected by at least one, e.g. by a pair of circumferentially-extending bars. For example, adjacent support rods may be connected by two circumferentially-extending bars, axially spaced so as to be connected to the two axial ends of the support rods.

In some embodiments, the track is a chain made up of a plurality of chain links. For example, each support rod and associated pair of bars described above can be considered to be a chain link within the track.

In order to adjust the circumferential length of the track, the number of links within the track can be varied.

The track may extend between opposing ends, the circumferential length (e.g. the number of chain links) between the opposing ends being variable.

The support may comprise a connecting body and the track may be connected or connectable to the connecting body. For example, one end of the track may be connected to the connecting body whilst the opposing end may be connectable to the connecting body as described below. The connecting body may be axially and/or circumferentially fixed relative to the track.

The connecting body may have opposing sides, spaced from one another in a circumferential direction of the support. Each of the opposing sides may comprise a connector portion for connection to the track e.g. for connection to a chain link of the track.

The or each connector portion may have at least one roller for abutment with the circumference of the pipe e.g. the/each connector portion may have two rollers spaced in an a direction aligned with the axis of the receiving channel/pipe. Where there are two rollers in the/each connector portion, the pair of rollers may be spaced by a respective connector rod about which the rollers may rotate, the connector rod(s) being fixedly connected to the connecting body.

As discussed above, one end of the track may be connected to the connecting body and this may be connected to the connecting rod of a first connector portion. The spacing in a circumferential direction between the connecting body (i.e. between the connecting rod of the first connector portion) and the connected end of the track may be adjustable.

The connector rod of the first connector portion may have an adjuster e.g. a threaded adjuster having a variable length in order to vary the spacing between the connecting body and the connected end of the track. For example, the connector rod of the first connector portion may have a threaded bore from which a threaded adjuster (e.g. a screw or bolt) extends. The threaded adjuster may also be received in a threaded bore provided in the adjacent support rod. The circumferential spacing between the connector rod of the first connector portion and adjacent support rod can be adjusted using the adjuster to adjust the circumferential length of the support (to tighten the track into the cutting configuration).

A second connector portion may comprise at least one (e.g. two) hook members which are configured to hook (e.g. releasably hook) onto the support rod of the link at the opposing end of the track. The hook members may extend from the connector rod of the second connector portion. The user can select the circumferential length of the track by choosing which support rod to hook the second connector portion to depending on the size of the pipe. Thus, it will be understood that the opposing end of the track that is connectable to the second connector portion may not, in fact, be the final link in the chain. The final link in the chain may be the opposing end where the pipe is of a maximum dimension but a link spaced from the end of the chain may form the opposing end of the track where the pipe is of less than the maximum dimension.

The hook members may be spaced i.e. spaced in a direction aligned with the axis of the receiving channel so as to hook over the support rod of the appropriate chain link each hook member in abutment with one of the rollers.

The track and connecting body together may completely encircle the pipe, in use. The connecting body may have an inner/lower surface or portion configured to abut the pipe. The inner/lower surface or portion may be curved or recessed to match a circumferential profile of the pipe. Thus, when the inner/lower surface or portion abuts the pipe in use, it can fit tightly against the outer circumference of the pipe.

The cutting tool is a milling tool i.e. it has multiple cutting edges on the end of a cylindrical shank. The milling tool has an axis of rotation that is perpendicular to the axis of the receiving channel. The milling tool may comprise two or more flutes around the cylindrical flank. The teeth may comprise chip breakers for reducing the size of swarf. The flank may have a diameter of between 5 and 15 mm, for example, around 10 mm.

In some embodiments, the cutting tool is moveable between a retracted (non-cutting) configuration in which a distal end of the tool is radially outwards of the inner surface of the support and an extended (cutting) configuration in which the distal end of the tool extends radially inwards of the inner surface of the support i.e. in the extended/cutting configuration, the cutting tool extends (radially) into the receiving channel defined by the support.

The cutting tool may be mounted on a tool mount which may be connected to the connecting body. The tool mount may be axially and/or circumferentially fixed relative to the track.

The tool mount may comprise an upper plate. The upper plate may be slidably mounted by at least one and preferably a plurality e.g. 2, or 3 or more pins, each pin received in a respective bore on the upper plate. The pins may each have an axis extending parallel to the axis of rotation of the cutting tool. At least one of the pins may extend from the connecting body. Additionally or alternatively, at least one e.g. two of the pins may extend between the upper plate and a lower plate. The lower plate may be substantially parallel to the upper plate and the upper plate may be slidably mounted relative to the lower plate.

The lower plate has an aperture through which the cutting tool extends. The lower plate may be connected to and extend from the connecting body e.g. from an upper portion or a lower portion (e.g. comprising the inner/lower surface) of the connecting body.

At least one of the pins may be fitted with a resilient spacer e.g. a spring such as a coiled spring wound around the/each pin. The or each spacer may resiliently bias the cutting tool into its retracted (non-cutting) configuration. For example, the or each spacer may resiliently bias the upper plate away from the lower plate.

The tool mount may further include a third, intermediate plate. The intermediate plate may be located between and substantially parallel to the lower plate and the upper plate. The or each spacer may resiliently bias the upper plate away from the intermediate plate.

The intermediate plate may be connected to and extend from the connecting body e.g. from the upper portion of the connecting body, in which case, the lower plate may extend from the lower portion of the connecting body. The intermediate plate may be fixedly connected to the lower plate, e.g. via one or more, preferably 2, posts. The posts may be received in respective recesses or bores of the intermediate and the lower plates.

The lower plate may have an inner surface (i.e. the surface facing a pipe in use) which may be curved or recessed to match the circumferential profile of the pipe. Thus, when the inner surface of the lower plate abuts the pipe in use, it can fit tightly against it.

The intermediate plate may have an aperture through which the cutting tool extends. The aperture in the intermediate plate may be axially aligned with the aperture in the lower plate. The aperture in the intermediate plate may be provided with a sealing element, e.g. circumferentially extending around the aperture. The sealing element may be formed of a compressible material, e.g. silicone or polyurethane foam. For example, the sealing element may be annular i.e. an O-ring.

The tool mount may comprise a tool mount chamber which may be defined between the lower and intermediate plates. A back wall of the chamber may be defined by the connecting body. The tool mount chamber may at least partially surround/enclose at least a portion of the milling tool.

The upper plate may be slidable towards the pipe/towards the lower plate/towards the intermediate plate into the extended (cutting) configuration with the bores in the upper plate moving down the shaft of the pin(s). When the/each pin is fitted with a resilient spacer, the upper plate may be slidable towards the pipe/lower plate/intermediate plate against the resilient bias of the spacer i.e. the pipe cutting apparatus may require application of a force (e.g. by the user) directed towards the pipe/lower plate to transition to the extended (cutting configuration).

In some embodiments, the pipe cutting apparatus comprises at least one locking member to lock the cutting tool in the extended (cutting) configuration. The or each locking member may comprise a spring pin. For example, there may be at least one spring pin provided on the lower plate or upper plate. There may be a spring pin receiving bore provided on the other of the upper plate or lower plate for receiving the spring pin in the extended (cutting) configuration. There may be two spring pins on opposing (in a circumferential direction) sides of the lower plate or upper plate. Similarly, the other of the upper plate or lower plate may comprise two spring pin receiving holes on its opposing sides for receiving the two spring pins.

In the cutting configuration, the upper plate may overlie and may be in abutment with the lower plate. Alternatively, where there is an intermediate plate, the upper plate may overlie and may be in abutment with the intermediate plate in the cutting configuration. The sealing element on the intermediate plate may abut the upper plate in the extended (cutting) configuration of the cutting tool.

A motor may be provided on the tool mount e.g. on the upper plate. The motor may be an air-driven motor. The motor may have a motor exhaust for expelling exhaust gas from the motor. The motor may be configured to drive the milling tool at a speed of at least 2000 rpm, for example at 2500 rpm or more.

In a preferred embodiment of the first aspect, the motor exhaust is connected to a swarf collection hose. A first end of the swarf collection hose is fluidly connected to the tool mount chamber.

The motor exhaust is connected to the swarf collection hose downstream of the chamber along a swarf collection direction such that, in use, a pressure differential is developed between the chamber and the swarf collection hose downstream of the connection with the motor exhaust, thereby suctioning swarf away from the milling tool.

Advantageously, in use, the chamber at least partially surrounds at least a portion of the milling tool, thereby containing swarf/debris produced by the milling tool therewithin. Then, by creating the pressure differential between the chamber and the swarf collection hose downstream of its connection with the motor exhaust, the swarf is suctioned away from the chamber and into the swarf collection hose. Conveniently, the exhaust gas from the motor acts as a motive gas stream driving the swarf collection. Thus, no separate power supply is required for swarf collection.

The pipe cutting apparatus may comprise a channel extending through the connecting body between the chamber and the swarf collection hose. The channel may extend axially within the connecting body, e.g. along the full axial length of the connecting body. The channel may have a smooth (i.e. having a low friction coefficient) inner surface, e.g. to reduce friction with the swarf.

At least a portion of the channel (e.g. proximal the milling tool) may be lined by a lining nozzle. The lining nozzle may be formed of plastic e.g. by 3D printing. The lining nozzle may have a smooth (i.e. having a low friction coefficient) inner surface. The lining nozzle may have an inclined floor along the swarf collection direction to better guide the swarf produced by the milling tool out of the channel.

The first end of the swarf collection hose may be fluidly connected to the tool mount chamber via the channel through the connecting body. That way, the channel may be used to guide swarf produced by the milling tool out of the chamber and through the connecting body.

The swarf collection hose may be as described for the second aspect below. The motor exhaust may comprise an exhaust hose as described for the second aspect. The apparatus may comprise a connector as described below for the second aspect.

In a second aspect, there is provided a cutting apparatus comprising:
a cutting tool;
a motor for driving the cutting tool, the motor having a motor exhaust for expelling exhaust gas therethrough;
a chamber which at least partially surrounds at least a portion of the cutting tool; and
a swarf collection hose having a first end fluidly connected to the chamber;
wherein the motor exhaust is connected to the swarf collection hose downstream of the chamber along a swarf collection direction such that, in use, a pressure differential is developed between the chamber and the swarf collection hose downstream of its connection with the motor exhaust, thereby suctioning swarf away from the cutting tool.

Advantageously, in use, the chamber at least partially surrounds at least a portion of the cutting tool, thereby containing swarf/debris produced by the cutting tool therewithin. Then, by developing the pressure differential between the chamber and the swarf collection hose downstream of its connection with the motor exhaust, the swarf is suctioned away from the cutting tool/chamber and into the swarf collection hose. Conveniently, the exhaust gas from the motor acts as a motive gas stream driving the swarf collection. Thus, no separate power supply is required. This provides an efficient swarf collection solution for a cutting apparatus at no additional power cost.

The cutting apparatus may be as described for the first aspect, although the cutting tool may be a cutting disc instead of a milling tool.

The motor exhaust may comprise an exhaust hose, the motor being connected to a first end of the exhaust hose, while a second end of the exhaust hose is connected to the swarf collection hose.

The motor exhaust, e.g. the exhaust hose, may be connected to the swarf collection hose via a connector.

The connector may have an upstream swarf collection hose inlet (hereinafter an upstream collection hose inlet) and a downstream swarf collection hose outlet (hereinafter downstream collection hose outlet) with an exhaust hose inlet interposed between the collection hose inlet and outlet. During use, the pressure at the collection hose inlet will be lower than the pressure at the collection hose outlet as a result of the pressure differential created by the motor exhaust. Thus, swarf will be drawn from the chamber into the collection hose inlet (e.g. via the connecting body channel) and will then be carried (by the motive gas entering from the exhaust hose inlet) to and out of the collection hose outlet.

A second end of the swarf collection hose (i.e. the end opposite to the end proximal the chamber) may be connected to or associated with a swarf collection vessel, preferably an air-permeable swarf collection vessel, such as an open weave fabric bag. Thus, the swarf may be easily separated from the gas stream and retained by the swarf collection vessel.

The inlets of the connector (and thus the axes of the exhaust hose and the upstream swarf collection hose) may form an angle, θ, of less than 45 degrees, preferably less than 30 degrees, and even more preferably less than 15 degrees. Generally, it is desirable to make the angle θ as small as possible to reduce turbulence in the gas stream at the point of connection of the exhaust hose to the swarf collection hose, thereby improving the efficiency with which the motive gas stream from the motor exhaust drives the air-swarf mixture in the swarf collection hose. Additionally or alternatively, the collection hose inlet and collection hose outlet may be substantially colinear.

In a third aspect, there is provided a method of forming a circumferentially-extending cut around a pipe having an elongate axis, using the apparatus of the first aspect, said method comprising:
providing a pipe within a pipe receiving channel of a support having a track with an inner surface facing the pipe; and
a forming the cut using a milling tool supported by the support.

The method may comprise at least partially e.g. fully encircling the circumference of the pipe within the receiving channel by the support/track i.e. the pipe may be provided with its axis coaxial with the axis of the pipe receiving channel.

In some embodiments, the method comprises adjusting (reducing) the circumferential length of the support/track from a non-cutting configuration to a cutting configuration in which the inner surface abuts the pipe. This allows the track of the apparatus to tightly grip the pipe. The reduction in length may be achieved by reducing the number of chain links in the track (e.g. using the second connector portion as described above) and/or by reducing the length of a threaded screw adjuster (e.g. using the first connector portion as described above).

In some embodiments, the method comprises moving the milling tool from a retracted (non-cutting) configuration in which a distal end of the tool is radially outwards of the inner surface of the support (e.g. within the tool mount chamber) to an extended (cutting) configuration in which the distal end of the tool extends radially inwards of the inner surface of the support (e.g. extends from the tool mount chamber).

The method may comprise rotating the support around the axis of the receiving channel/pipe. The method may comprise rotating the support on one or more rollers (e.g. on one or more rollers as described above for the first aspect) around the circumference of the pipe.

In some embodiments, the method comprises locking the milling tool in the extended (cutting) configuration e.g. using at least one locking member such as a spring pin or a screw.

In some embodiments, the method comprises rotating the milling tool using a motor e.g. an air-driven motor. The method may comprise rotating the milling tool at of speed of at least 2000 rpm such as at a speed of 2500 rpm or greater.

In some embodiments, the method further comprises suctioning swarf/debris away from the milling tool e.g. away from the tool mount chamber. This may be achieved by creating a pressure differential between the tool mount chamber and a downstream portion of a swarf collection hose e.g. by connecting an exhaust of the motor (e.g. via an exhaust hose) to the swarf collection hose, the swarf collection hose being in fluid communication with the tool mount chamber. The method may further comprise connecting the motor exhaust (e.g. the exhaust hose) to the swarf collection hose at an angle, θ, of less than 45 degrees, preferably less than 30 degrees, and even more preferably less than 15 degrees

In a fourth aspect, there is provided a method of forming a cut, using the cutting apparatus of the second aspect, said method comprising:

forming a cut using a cutting tool at least a portion of which is at least partially surrounded by the chamber;

suctioning swarf from the chamber along a swarf collection hose by creating a pressure differential between the chamber and a downstream portion of the swarf collection hose e.g. by connecting the motor exhaust to the swarf collection hose downstream of the chamber. This will create a pressure differential between the chamber and the swarf collection hose downstream of its connection with the motor exhaust.

In some embodiments, the method comprises connecting the motor exhaust (e.g. the exhaust hose) to the swarf collection hose at an angle, θ, of less than 45 degrees, preferably less than 30 degrees, and even more preferably less than 15 degrees

In some embodiments, the method is a method of forming a circumferentially-extending cut around a pipe having an elongate axis, said method comprising providing a pipe within a pipe receiving channel of a support having a track with an inner surface facing the pipe.

The method may comprise at least partially e.g. fully encircling the circumference of the pipe within the receiving channel by a support/track i.e. the pipe may be provided with its axis coaxial with the axis of the pipe receiving channel.

In some embodiments, the method comprises adjusting (reducing) the circumferential length of the support/track from a non-cutting configuration to a cutting configuration in which the inner surface abuts the pipe. This allows the track of the apparatus to tightly grip the pipe. The reduction in length may be achieved by reducing the number of chain links in the track (e.g. using the second connector portion as described above) and/or by reducing the length of a threaded screw adjuster (e.g. using the first connector portion as described above).

In some embodiments, the method comprises moving the cutting tool from a retracted (non-cutting) configuration (e.g. in which a distal end of the tool is radially outwards of the inner surface of the support, e.g. partially within the chamber) to an extended (cutting) configuration (e.g. in which the distal end of the tool extends radially inwards of the inner surface of the support, e.g. extends from the chamber).

The method may comprise rotating the support around the axis of the receiving channel/pipe. The method may comprise rotating the support on one or more rollers (e.g. on one or more rollers as described above for the first aspect) around the circumference of the pipe.

In some embodiments, the method comprises locking the milling tool in the extended (cutting) configuration e.g. using at least one locking member such as a spring pin or a screw.

In some embodiments, the method comprises rotating the milling tool using a motor e.g. an air-driven motor. The method may comprise rotating the milling tool at of speed of at least 2000 rpm such as at a speed of 2500 rpm or greater.

### SUMMARY OF THE FIGURES

Embodiments illustrating the principles of the invention will now be discussed with reference to the accompanying figures in which:

FIG. 1 shows a pipe cutting apparatus of the first aspect with a pipe inserted into the pipe receiving channel;

FIG. 2 shows a connecting body of the pipe cutting apparatus of FIG. 1;

FIG. 3 shows the first connector portion of the pipe cutting apparatus of FIG. 1;

FIG. 4 shows the pipe cutting apparatus with the milling tool in the retracted configuration;

FIG. 5 shows the pipe cutting apparatus with the milling tool in the extended configuration;

FIGS. 6-8 show the circumferential movement of the pipe cutting apparatus around the pipe;

FIGS. 9 to 12 show various views of a cutting apparatus of the second aspect; and

FIG. 13 shows a side sectional view of a connector connecting the cutting apparatus to the swarf collection hose of FIGS. 9 to 12.

### DETAILED DESCRIPTION

Aspects and embodiments will now be discussed with reference to the accompanying figures. Further aspects and embodiments will be apparent to those skilled in the art.

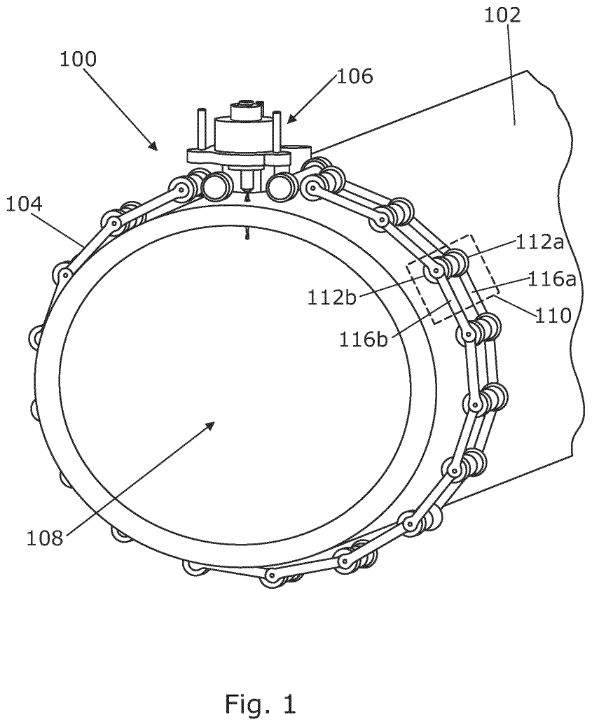

FIG. 1 shows a pipe cutting apparatus 100 for forming a circumferentially extending cut around a pipe 102. The pipe cutting apparatus 100 comprises a support having a track 104 and a connecting body 106. Opposing ends of the track 104 are connected to opposing sides of the connecting body 106 such that the track 104 and the connecting body 106 define a pipe receiving channel 108. In FIG. 1, a pipe 102 is disposed within the pipe receiving channel 108 such that the inner surface of the support (i.e. the inner surface of the track 104 and connecting body 106) abuts and completely encircles the pipe 102 with the axes of the pipe 102 and the pipe receiving channel 108 being aligned (and coaxial).

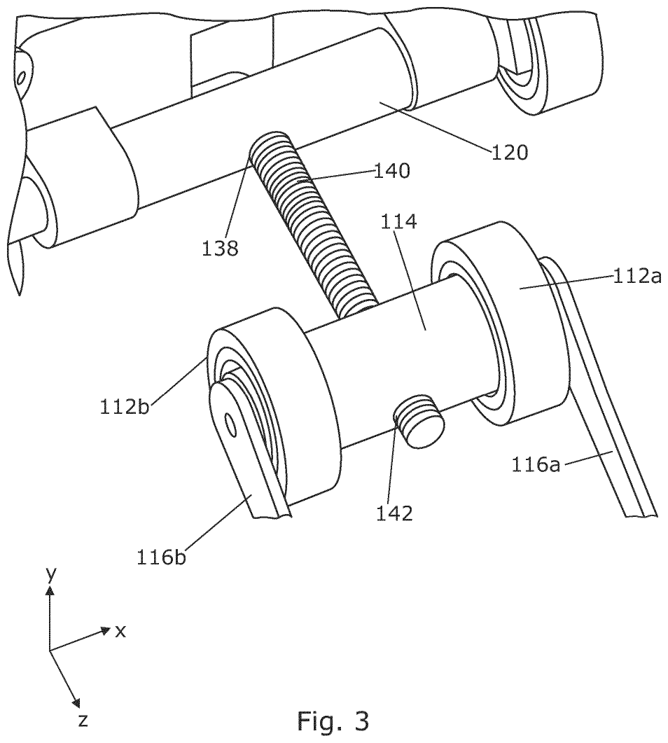

The track 104 is a chain made up of a plurality of chain links 110. Each chain link 110 comprises a pair of rollers 112a/b, a support rod 114 (visible in FIGS. 3, 4, 5) and a pair of circumferentially extending bars 116a/b. The support rod 114 connects and spaces the two rollers 112a/b of a roller pair in a direction parallel to the axis of the receiving channel 108/pipe 102. The rollers 112a/b are rotatable about their respective support rod 114. Therefore, the axis of rotation of the rollers 112a/b is parallel to the axis of the receiving channel 108/pipe 102. The surface of each roller 112a/b is formed of rubber. The two circumferentially extending bars 116a/b in a pair are axially spaced so that they are connected to the two axial ends of the support rod 114. The circumferentially extending bars 116a/b connect adjacent support rods 114 of adjacent chain links 110. The chain links 110 are connected such that the rollers 112a/b are equally spaced along the circumferential length of the track 104.

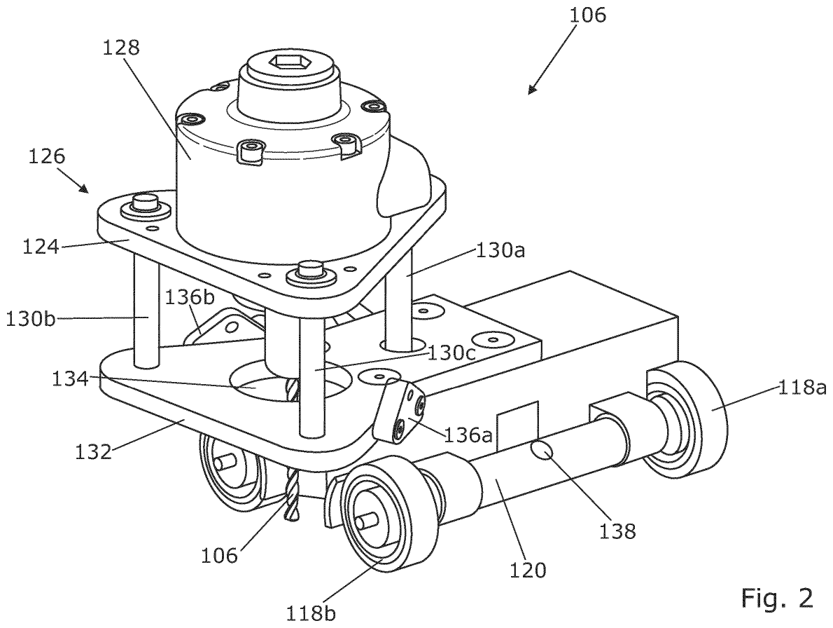

The connecting body 106 is shown in more detail in FIG. 2. Each of the opposing sides of the connecting body 106 comprises a connector portion for connection to a chain link 110 of the track 104. Only the first connector portion is clearly visible in FIG. 2. Each connector portion has two rollers 118a/b for abutment with the circumference of the pipe 102. The two rollers 118a/b are spaced in a direction aligned with the axis of the receiving channel 108/pipe 102 by a connector rod 120 about which the rollers 118a/b rotate. The connector rod 120 is fixedly connected to the connecting body 106.

The second connector portion (not visible) comprises two hook members extending from the connector rod and spaced by a distance matching the length of the support rods 114 between the rollers 112a/b.

An inner surface (not shown) of the connecting body 106 is curved to match a circumferential profile of the pipe. Thus, when the inner surface abuts the pipe in use, it can fit tightly against the outer circumference of the pipe. The inner surface is comprised by a lower portion of the connecting body.

A cutting tool, which is a milling tool 122 formed of high speed steel, is mounted on an upper plate 124 of a tool mount 126. The milling tool 122 has an axis of rotation that is perpendicular to the axis of the receiving channel 108. An air-driven motor 128 is also provided on the upper plate 124 of the tool mount 126 for driving the milling tool 122 at a speed of 2500 rpm. The milling tool has two flutes and teeth with chip breakers formed at the end of a cylindrical shaft having a diameter of 10 mm.

The upper plate 124 of the tool mount 126 is slidably mounted on three pins 130a/b/c which are slidably received in a respective bore of the upper plate 124. One of the pins 130a extends from the connecting body 106 to the upper plate 124 along an axis parallel to the axis of rotation of the milling tool 122. Two of the pins 130b/c extend from a lower plate 132 and the upper plate 124 along an axis parallel to the axis of rotation of the milling tool 122. The lower plate 132 of the tool mount 126 is connected to the upper portion of the connecting body 106 and has an aperture 134 through which the milling tool 122 extends.

The milling tool 122 is moveable between a retracted (non-cutting) configuration in which a distal end of the tool 122 is radially outwards of the inner surface of the support/connecting body and an extended (cutting) configuration in which the distal end of the tool 122 extends radially inwards of the inner surface of the support/connecting body. It is moved to the position by sliding the bores of the upper plate 124 down the shafts of the pins 130a/b/c. In the extended (cutting) position, the upper plate 124 overlies and is in abutment with the lower plate 132. There are two spring pins 136a/b on opposing sides of the lower plate 132. The spring pins 136a/b can be used to lock the milling tool 122 in the extended (cutting) configuration by locking in spring pin receiving bores provided on opposing sides of the upper plate 124. In FIG. 2, the milling tool 122 is in the retracted (non-cutting) configuration.

The circumferential length of the track 104 is adjustable. This allows the receiving channel 108 to accommodate different sized pipes, for example between 250 and 630 mm. This adjustability further allows the apparatus 100 to be alternately configured in a non-cutting configuration (for insertion/removal of a pipe within the pipe receiving channel 108) and a cutting configuration (where the inner surface of the support/track 104 is in abutment with the circumference of the pipe).

The circumferential length of the track 104 is variable by two methods.

Firstly, the spacing in a circumferential direction between the connecting body 106 and one end of the track 104 adjustable. As shown in FIG. 3, this is possible, as the connector rod 120 of the first connector portion comprises a threaded bore 138 from which a threaded screw 140 extends, and the adjacent support rod 114 at the connected end of the track 104 has a threaded bore 142 through which the screw 140 can be extended by adjustable amounts.

Secondly, the number of track chain links 110 can be varied to adjust the circumferential length of the track 104. The user can select the circumferential length of the track by choosing which support rod to hook the second connector portion to depending on the size of the pipe.

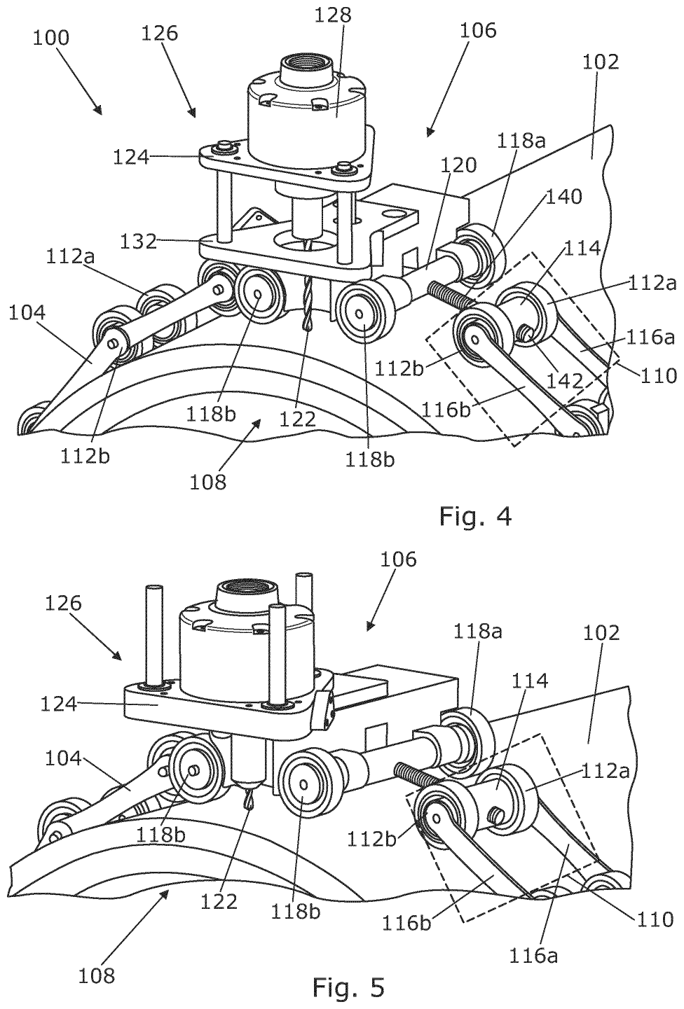

The cutting of a pipe 102 using the pipe using the pipe cutting assembly 100 will now be described with reference to FIGS. 4 to 8.

The connecting body 106 is placed on the pipe 102 with one end of the track connected to the first connector portion.

The opposing end of the track 104 is then connected to the body 106 using the hooks on the second connector portion. The number of chain links 110 in the track 104 is selected to the size of the pipe 102 being cut.

The connecting body 106 and the track 104 together form the support. As shown in FIG. 4, opposing ends of the track 104 are connected to opposing sides of the connecting body 106 such that the track 104 and connecting body 106 together completely encircle the pipe 102. The pipe 102 extends through the receiving channel 108 defined by the track 104 and the connecting body 106, the axes of the receiving channel 108 and the pipe 102 being aligned.

The circumferential length of the track 104 is decreased to tighten the apparatus 100 from a non-cutting configuration to a cutting configuration. This is done by adjusting the position of the support rod 114 at the end of the track 104 along the screw 140 of the first connector portion connector rod 120.

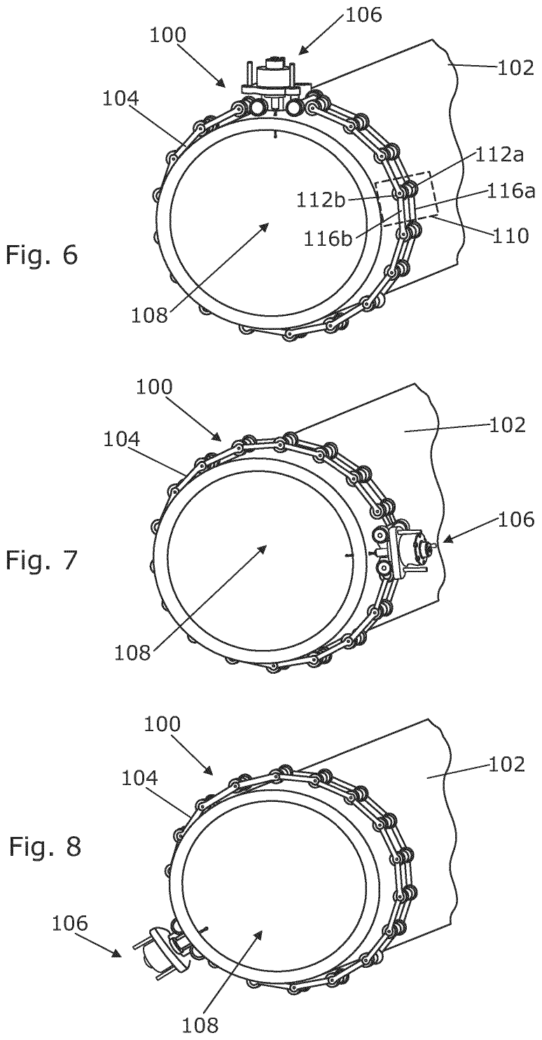

The air driven motor 128 is activated, rotating the milling tool 122 at 2500 rpm. The milling tool 122 is moved from its retracted (non-cutting) position, as shown in FIG. 4, to its extended (cutting) position, as shown in FIG. 5, by moving the upper plate 124 of the tool mount 126 downwards into abutment with the lower plate 132 of the tool mount 126. In the extended (cutting) configuration, the milling tool 122 extends (radially) into the receiving channel 108, and therefore into the pipe 102. The milling tool 122 is locked in the extended (cutting) position using the spring pins 136a/b to lock the upper plate 124 to the lower plate 132.

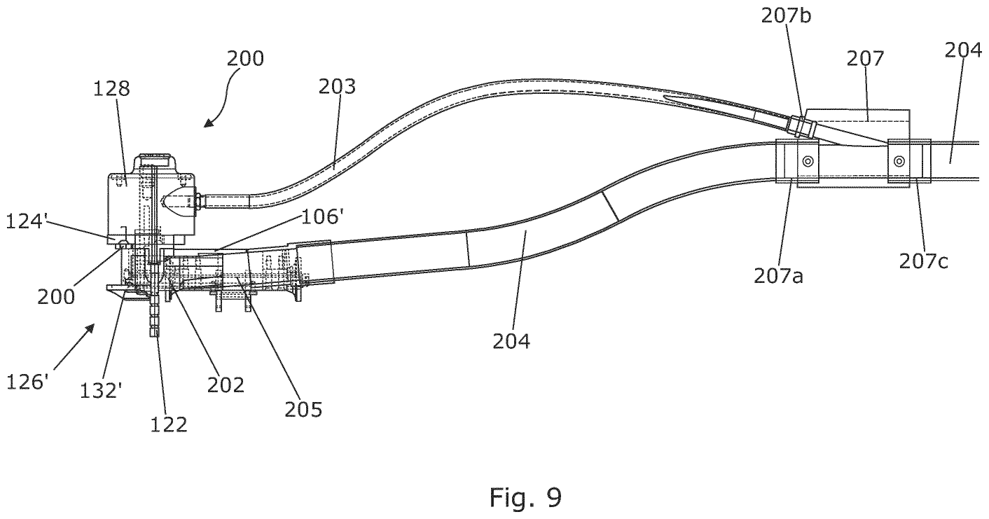

The support is rotated around the axis of the pipe 102, as shown in FIGS. 6 to 8. The rollers 112a/b of the connecting body 106 and the rollers 118a/b of the track 104 provide the inner surface of the support and abut the pipe 102. The support rolls around the circumference of the pipe 102 on the rollers 112a/b, 118a/b effecting a circumferential cut as it travels around the pipe.

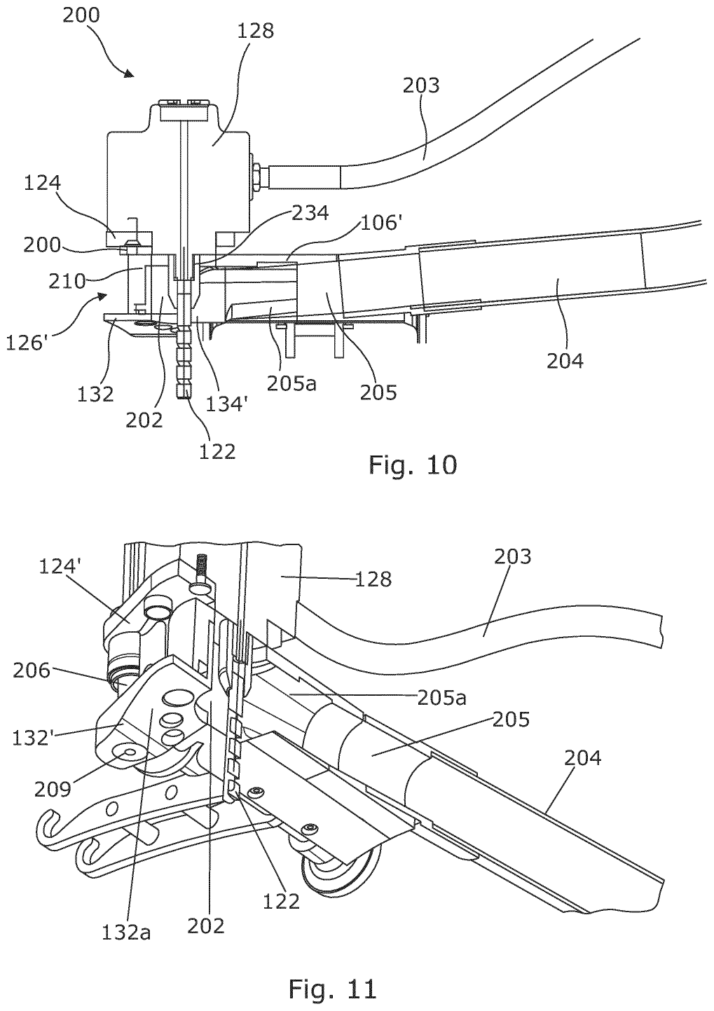

FIGS. 9 to 12 show various views of a cutting apparatus 200 according to the second aspect connected to a swarf collection hose 204. The cutting apparatus 200 of FIGS. 9 to 12 shares features with the cutting apparatus 100 of FIGS. 1 to 8. Thus, like features have like reference numerals.

FIG. 9 shows a side sectional view of the cutting apparatus 200 connected to the swarf collection hose 204. The cutting apparatus 200 includes a tool mount 126′, a cutting tool 122 mounted on the tool mount, and a connecting body 106′. As in FIGS. 1 to 8, the cutting tool 122 is a milling tool but may be another type of cutting tool such as a disc cutter.

FIGS. 10 and 11 respectively show close-up side and perspective sectional views of the cutting apparatus 200 of FIG. 9, the cutting tool 122 being in the extended (cutting) configuration.

The tool mount 126′, it includes a lower plate 132′, an upper plate 124′, and an intermediate plate 212 interposed between the lower 132′ and upper 124′ plates. The three plates are mutually parallel and overlie each other. The lower plate 132′ is connected to and extends from a lower portion of the connecting body 106′ comprising a curved inner surface (as described in relation to FIG. 1), while the intermediate plate 212 is connected to and extends from an upper portion of the connecting body 106′, the upper and lower portions being axially spaced from one another. The intermediate plate 212 is fixedly connected to the lower plate 132′ via a pair of posts 206 (one of which is visible in FIG. 11). The posts 206 are received in respective bores 209 of the intermediate 212 and the lower plates 132′. The lower 132′ and upper 124′ plates are connected via a pair of pins 130′a/b received by respective bores formed in the respective plates (best seen in FIG. 12). The pins may each be fitted with a resilient spacer (not shown), e.g. a coiled spring wound around the respective pin. Each spacer resiliently biases the upper plate 124′ away from the lower plate 132′ (and from the intermediate plate 212), i.e. in the retracted (non-cutting configuration).

The lower plate 132′ has an inner surface 132a (i.e. the surface facing a pipe in use) which is curved to match the circumferential profile of the pipe (shown in FIG. 11). Thus, when the inner surface 132a of the lower plate abuts the pipe in use, it can fit tightly against it. The lower plate 132′ and the intermediate plate 212 have respective apertures 134′, 234 through which the milling tool 122 extends in the cutting configuration. The two apertures 134′, 234 are axially aligned with one another. The aperture 234 in the intermediate plate 212 is provided with a sealing element (not shown), e.g. an O-ring, circumferentially extending around the aperture. The sealing element is formed of a compressible material, e.g. silicone or polyurethane foam.

The lower and intermediate plates together form a tool mount chamber 202. The chamber 202 is further defined by a front 210 and side (not shown) walls extending radially between the lower 132′ and intermediate 212 plates. The side walls are mutually parallel and circumferentially spaced, while the front wall 210 is perpendicular to the side walls and extends circumferentially. In this example, the chamber 202 does not include a back wall but instead opens to the connecting body 106′. Advantageously, in use, i.e. in the cutting configuration, the chamber 202 at least partially surrounds at least a portion of the milling tool 122, thereby containing swarf produced by the milling tool therewithin.

The upper plate 124′ is slidable towards the intermediate plate 212 into the extended (cutting) configuration with the bores in the upper plate moving down the shaft of the pin(s) 130′a/b. The upper plate 124′ is slidable towards the intermediate plate 212 against the resilient bias of the spacers and thus the cutting apparatus 200 requires application of a force (e.g. by the user) directed towards the lower plate 132′ to transition to the extended (cutting configuration). Once the cutting tool is in the cutting configuration, as shown in FIGS. 9 to 11, it can be locked in place by a locking member. This may be a couple of spring pins 136a/b like in FIGS. 1 to 8, or it may be a single bolt-screw arrangement (not shown), e.g. provided frontally on the cutting apparatus.

Further, in the cutting configuration, the upper plate 124′ overlies and is in abutment with the intermediate plate 212. Consequently, the sealing element on the intermediate plate 212 abuts the upper plate 124′ to seal the upper plate to the aperture 234 of the intermediate plate and therefore to the tool mount chamber 202.

As in FIGS. 1 to 8, the upper plate 124′ of the tool mount 126′ supports an air-driven motor 128 for driving the milling tool 122. The motor 128 has a motor exhaust for expelling exhaust gas from the motor, the motor exhaust comprising an exhaust hose 203. The motor 128 may be configured to drive the milling tool 122 at a speed of at least 2000 rpm, for example at 2500 rpm or more.

The connecting body 106′ differs from the connecting body 106 of FIGS. 1 to 8 in that it comprises a channel 205 extending axially therethrough, i.e. along the full axial length of the connecting body 106′. The channel 206 has a smooth (i.e. having a low friction coefficient) inner surface, e.g. to reduce friction with the swarf.

At least a portion of the channel 205 (in this example proximal the milling tool 122) is lined by a lining nozzle 205a. The lining nozzle 205a can be formed of plastic e.g. by 3D printing. The lining nozzle 205a has a smooth (i.e. having a low friction coefficient) inner surface. The lining nozzle 205a also has an inclined floor along the swarf collection direction to better guide the swarf produced by the milling tool 122 out of the channel 205.

Turning to FIG. 12, a first end of the swarf collection hose 204 is connected to a back opening of the channel 205 of the connecting body 106′ (i.e. back here means distal the milling tool 122). Thus, the swarf collection hose 124 is connected to the tool mount chamber 202 via the channel 205. That way, the channel 205 is used to guide swarf produced by the milling tool 122 out of the chamber 202 and through the connecting body 106′.

The exhaust hose 203 is connected to the swarf collection hose 204 via a connector 207 downstream of the chamber 202 along the swarf collection direction. Thus, in use a pressure differential is developed between the chamber 202 and the swarf collection hose 204 downstream of the connector 207, thereby suctioning swarf away from the milling tool 122. By creating the pressure differential between the chamber 202 and the swarf collection hose 204 downstream of its connection with the exhaust hose 203, the swarf is suctioned away from the chamber 202 and into the swarf collection hose 204. Conveniently, the exhaust gas from the motor 128 acts as a motive gas stream driving the swarf collection. Thus, no separate power supply is required for swarf collection. In this example, an air inlet hose 211 is also shown, the air inlet hose supplying air to the motor 128 to drive it.

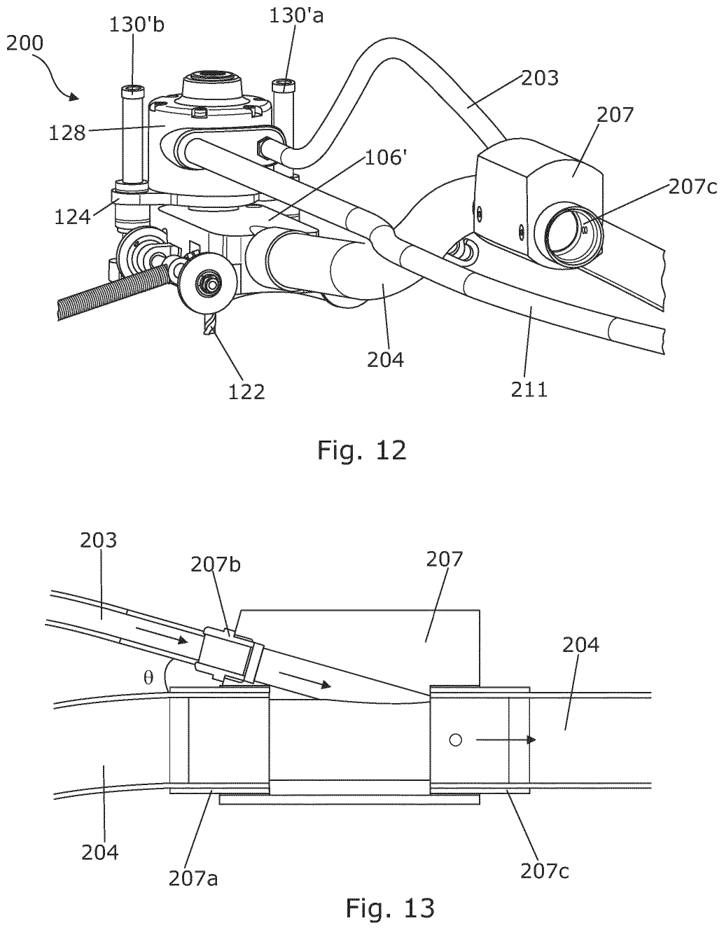

Finally, FIG. 13 shows a detailed side sectional view of the connector 207. The connector 207 is interposed between the first and second ends of the swarf collection hose 204 such that the connector 207 connects to the swarf collection hose 204 via an upstream swarf collection hose inlet 207a (herein after collection hose inlet) and a downstream swarf collection hose outlet 207c (hereinafter collection hose outlet). The connector 207 includes an exhaust hose inlet 207b interposed between the collection hose inlet 207a and outlet 207c. The collection hose inlet 207a and collection hose outlet 207c are substantially colinear in this example.

The inlets 207a/b of the connector 207 (and thus the axes of the exhaust hose 203 and the upstream swarf collection hose 204) form an angle, θ, of less than 45 degrees, preferably less than 30 degrees, and even more preferably less than 15 degrees. In this example, θ is about 14 degrees. Generally, it is desirable to make the angle θ as small as possible to reduce turbulence in the gas stream at the point of connection of the exhaust hose 203 to the swarf collection hose 204, thereby improving the efficiency with which the motive gas stream from the motor exhaust drives the air-swarf mixture in the swarf collection hose 204.

During use, the pressure at the collection hose inlet 207a is lower than the pressure at the collection hose outlet 207c as a result of the pressure differential created by the motor exhaust. Thus, swarf is drawn from the chamber 202 into the collection hose inlet 207a (e.g. via the connecting body channel 205) and is then carried (by the motive gas entering from the exhaust hose inlet 207b) to and out of the collection hose outlet 207c. The direction of exhaust gas flow inside the exhaust hose 203, as well as that of the swarf-gas stream inside the swarf collection hose 204 is indicated by arrows in FIG. 13.

The second end (not shown) of the swarf collection hose (i.e. the end not connected to the back opening of the channel 205 of the connecting body 106′) is connected to a swarf collection vessel (not shown). For example, the swarf collection vessel is an open weave fabric bag which is permeable to gas but retains swarf. Thus, the swarf can be easily separated from the gas stream and retained by the swarf collection vessel.

The cutting apparatus 200 described with reference to FIGS. 9 to 13 is operable to cut a pipe in the same manner as the cutting apparatus 100 of FIGS. 1 to 8. Additionally, the cutting apparatus 200 can additionally be operated to suction swarf away from the milling tool 122 in use by connecting the exhaust hose 203 to the swarf collection hose 204 to create a pressure differential between the chamber 202 and the swarf collection hose 204 downstream of the connector 207.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof. While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A pipe cutting apparatus for forming a circumferentially-extending cut around a pipe having an elongate axis, said apparatus comprising:
a support having a track at least partially defining a pipe receiving channel having an axis, and having an inner surface configured to abut a pipe within the pipe receiving channel; and
a cutting tool supported by the support, wherein the cutting tool is a milling tool.

2. An apparatus according to claim 1 wherein the support is configured to completely encircle the pipe.

3. An apparatus according to claim 1 or 2 wherein the circumferential length of the support/track is adjustable.

4. An apparatus according to any one of claims 1 to 3 wherein the support is configured to rotate around the axis of the receiving channel/pipe.

5. An apparatus according to claim 4 wherein the track comprises at least one roller.

6. An apparatus according to claim 5 wherein the track comprises a plurality of rollers equally spaced along the circumferential length of the track.

7. An apparatus according to any one of the preceding claims wherein the support further comprises a connecting body connecting opposing ends of the track and wherein the spacing in a circumferential direction between the connecting body and at least one end of the track is adjustable.

8. An apparatus according to claim 7 comprising an adjuster for adjusting the spacing.

9. An apparatus according to any one of the preceding claims wherein the track comprises a plurality of chain links.

10. An apparatus according to claim 9 wherein the number of chain links in the track is variable.

11. An apparatus according to any one of the preceding claims wherein the cutting tool is moveable between a retracted (non-cutting) configuration in which a distal end of the tool is radially outwards of the inner surface of the support and an extended (cutting) configuration in which the distal end of the tool extends radially inwards of the inner surface of the support.

12. An apparatus according to claim 11 further comprising at least one locking member for locking the cutting tool in the extended (cutting) configuration.

13. An apparatus according to any one of the preceding claims further comprising:
a chamber at least partially surrounding at least a portion of the cutting tool;
a swarf collection hose having a first end fluidly connected to the chamber;
a motor for driving the cutting tool, the motor having a motor exhaust for expelling exhaust gas therethrough,
wherein the motor exhaust is connected to the swarf collection hose downstream of the chamber along a swarf collection direction such that, in use, a pressure differential is developed between the chamber and the swarf collection hose downstream of its connection with the motor exhaust, thereby suctioning swarf away from the cutting tool.

14. A cutting apparatus comprising:
a cutting tool;
a motor for driving the cutting tool, the motor having a motor exhaust for expelling exhaust gas therethrough;
a chamber which at least partially surrounds at least a portion of the cutting tool; and
a swarf collection hose having a first end fluidly connected to the chamber;
wherein the motor exhaust is connected to the swarf collection hose downstream of the chamber along a swarf collection direction such that, in use, a pressure differential is developed between the chamber and the swarf collection hose downstream of its connection with the motor exhaust, thereby suctioning swarf away from the cutting tool.

15. An apparatus according to claim 13 or 14, wherein the motor exhaust is connected to the swarf collection hose via a connector.

16. An apparatus according to claim 15 wherein the connector comprises an upstream swarf collection hose inlet and a downstream swarf collection hose outlet, with an exhaust hose inlet interposed between the swarf collection hose inlet and outlet.

17. An apparatus according to claim 16 wherein the inlets of the connector form an angle, θ, of less than 45 degrees.

18. An apparatus according to claim 17 wherein the inlets of the connector form an angle, θ, of less than 30 degrees

19. An apparatus according to claim 18 wherein the inlets of the connector form an angle, θ, of less than 15 degrees

20. An apparatus according to any one of claims 13 to 19, wherein a second end of the swarf collection hose is connected to an air-permeable swarf collection vessel.

21. A method of forming a cut, said method comprising:
forming a cut using a cutting tool at least a portion of which is at least partially surrounded by a chamber;
suctioning swarf from the chamber along a swarf collection hose by creating a pressure differential between the chamber and a downstream portion of the swarf collection hose.

22. A method according to claim 21 comprising connecting a motor exhaust to the swarf collection hose to create the pressure differential between the chamber and the swarf collection hose downstream of its connection with the motor exhaust.

23. A method according to claim 21 for forming a circumferentially-extending cut around a pipe having an elongate axis, said method comprising providing a pipe within a pipe receiving channel of a support having a track with an inner surface facing the pipe.

24. A method of forming a circumferentially-extending cut around a pipe having an elongate axis, said method comprising:
providing a pipe within a pipe receiving channel of a support having a track with an inner surface facing the pipe; and
a forming the cut using a cutting tool supported by the support, wherein the cutting tool is a milling tool.

25. A method according to claim 24 further comprising suctioning swarf from a chamber at least partially enclosing at least a portion of the milling tool by creating a pressure differential between the chamber and a downstream portion of a swarf collection hose.

26. A method according to claim 25 comprising connecting a motor exhaust to the swarf collection hose to create the pressure differential between the chamber and the swarf collection hose downstream of its connection with the motor exhaust.

27. A method according to any one of claims 23 to 26 comprising fully encircling the circumference of the pipe within the receiving channel.

28. A method according to claim 27 comprising adjusting the circumferential length of the track from a non-cutting configuration to a cutting configuration in which the inner surface abuts the pipe.

29. A method according to any one of claims 23 to 28 comprising moving the cutting tool from a retracted (non-cutting) configuration in which a distal end of the tool is radially outwards of the inner surface of the support to an extended (cutting) configuration in which the distal end of the tool extends radially inwards of the inner surface of the support.

30. A method according to any one of claims 23 to 29 comprising rotating the support around the axis of the receiving channel/pipe.
